(19) United States
(12) Patent Application Publication
(10) Pub. No.: US 2008/0097069 A1
(43) Pub. Date: Apr. 24, 2008

(54) POLY(ARYLENE ETHER) METHOD AND COMPOSITION

(76) Inventors: Hua Guo, Selkirk, NY (US); Robert Howe, Greenville, NY (US); Edward N. Peters, Lenox, MA (US)

Correspondence Address: CANTOR COLBURN LLP - SABIC (NORYL), 20 Church Street, 22nd Floor, Hartford, CT, 06103, US

(21) Appl. No.: 11/551,407

(22) Filed: Oct. 20, 2006

(51) Int. Cl. C08G 61/02

(52) U.S. Cl. 528/86

(57) ABSTRACT

A method for producing a capped poly(arylene ether) having a low concentration of metal impurities is described. The method includes treating a solution of a capped poly(arylene ether) with a chelant to bind the polymerization catalyst metal, and separating the chelated metal from the capped poly(arylene ether). Capped poly(arylene ether)s prepared by the method are also described, as are curable compositions that include them.

### BACKGROUND OF THE INVENTION

Poly(arylene ether) resin is a type of plastic known for its excellent water resistance, dimensional stability, and inherent flame retardancy. Properties such as strength, stiffness, chemical resistance, and heat resistance can be tailored by blending it with various other plastics in order to meet the requirements of a wide variety of consumer products, including plumbing fixtures, electrical boxes, automotive parts, and coated wire. Poly(arylene ether)s are also used as additives to thermoset resins, which are materials that cure to form very hard plastics. The addition of a poly(arylene ether) can make a cured thermoset resin much less brittle.

Poly(arylene ether)s are typically synthesized by oxidative polymerization of a phenolic monomer. These polymerization reactions are often catalyzed by a metal (a “catalyst metal”), such as copper or manganese, which is maintained in solution as an amine complex. The catalyst metal is then separated from the poly(arylene ether) by chelation with an aqueous chelant solution. See, for example, U.S. Pat. No. 3,733,301 to Modan, U.S. Pat. No. 3,783,147 to Calicchia et al., and U.S. Pat. No. 3,838,102 to Bennett et al. Despite this chelation step, a small amount of the catalyst metal can remain in the isolated poly(arylene ether). In the working examples of the Modan patent, for example, residual copper levels of 15.5 and 15.0 parts per million by weight were found in the poly(arylene ether)s of Examples 1 and 5, respectively.

For some uses and particularly for use in thermoset compositions, the poly(arylene ether) can be modified by “capping” the terminal hydroxy groups with a polymerizable group such as a methacrylate ester. Whatever catalyst metal is present in the uncapped poly(arylene ether) is typically carried over to the capped poly(arylene ether). The presence of even small amounts of catalyst metal in both uncapped and capped poly(arylene ether)s has been observed to adversely affect their thermal stability. Residual catalyst metal ion is particularly detrimental to capped poly(arylene ether)s because it can adversely affect the curing rates of a thermoset resin to which the capped poly(arylene ether) is added. Residual catalyst metal ion can also adversely affect the dielectric properties of the cured thermoset resin. There is therefore a need for methods of preparing capped poly(arylene ether)s with reduced levels of residual catalyst metal.

### BRIEF DESCRIPTION OF THE INVENTION

A capped poly(arylene ether) with an exceptionally low level of residual catalyst metal can be prepared by a method, comprising: oxidatively polymerizing a phenolic monomer in the presence of a solvent and a catalyst metal to form a polymerization reaction mixture comprising a poly(arylene ether), solvent, catalyst metal, and water; separating water from the polymerization reaction mixture to form a solution comprising poly(arylene ether), solvent, and catalyst metal; combining a capping agent with the solution comprising poly(arylene ether), solvent, and catalyst metal, and reacting the poly(arylene ether) and the capping agent to form a capping reaction mixture comprising a capped poly(arylene ether), solvent, and catalyst metal; combining a chelant with the capping reaction mixture; and separating the combined chelant and capping reaction mixture to yield a purified solution and an aqueous phase; wherein the purified solution comprises capped poly(arylene ether) and solvent; and wherein the aqueous phase comprises chelant and catalyst metal.

Another embodiment is a method of preparing a capped poly(arylene ether) resin comprising: oxidatively polymerizing 2,6-dimethylphenol in the presence of toluene and a polymerization catalyst comprising copper to form a polymerization reaction mixture comprising a poly(arylene ether), toluene, copper, and water; separating water from the polymerization reaction mixture to form a solution comprising poly(arylene ether), toluene, and copper; combining (meth)acrylic anhydride with the solution comprising poly(arylene ether), toluene, and copper, and reacting the (meth)acrylic anhydride and the poly(arylene ether) to form a capping reaction mixture comprising a (meth)acrylate-capped poly(arylene ether), toluene, and copper; combining an aqueous chelant solution with the capping reaction mixture; wherein the aqueous chelant solution comprises an alkali metal salt of nitrilotriacetic acid; separating the combined aqueous chelant solution and capping reaction mixture to yield a purified solution and an aqueous phase; wherein the purified solution comprises (meth)acrylate-capped poly(arylene ether) and toluene; and wherein the aqueous phase comprises chelant and copper; and isolating the (meth)acrylate-capped poly(arylene ether); wherein the isolated (meth)acrylate-capped poly(arylene ether) comprises about 0.1 to about 1 part per million by weight of copper.

Another embodiment is a method of preparing a capped poly(arylene ether) resin comprising: oxidatively polymerizing 2,6-dimethylphenol in the presence of toluene and a polymerization catalyst comprising copper to form a polymerization reaction mixture comprising a poly(arylene ether), toluene, copper, and water; separating water from the polymerization reaction mixture to form a solution comprising poly(arylene ether), toluene, and copper; removing toluene from the polymerization reaction mixture or the solution comprising poly(arylene ether), toluene, and copper; combining (meth)acrylic anhydride with the solution comprising poly(arylene ether), toluene, and copper, and reacting the (meth)acrylic anhydride and the poly(arylene ether) to form a capping reaction mixture comprising a (meth)acrylate-capped poly(arylene ether), toluene, and copper; adding toluene to the capping reaction mixture to form a diluted capping reaction mixture; combining an aqueous chelant solution with the diluted capping reaction mixture; wherein the aqueous chelant solution comprises an alkali metal salt of nitrilotriacetic acid; separating the combined aqueous chelant solution and diluted capping reaction mixture to yield a purified solution and an aqueous phase; wherein the purified solution comprises (meth)acrylate-capped poly(arylene ether) and toluene; and wherein the aqueous phase comprises chelant and copper; removing toluene from the purified solution to yield a concentrated purified solution; and isolating the (meth)acrylate-capped poly(arylene ether) from the concentrated purified solution; wherein the isolated (meth)acrylate-capped poly(arylene ether) comprises about 0.1 to about 1 part per million by weight of copper.

Another embodiment is a method of preparing a capped poly(arylene ether) resin comprising: oxidatively polymerizing 2,6-dimethylphenol in the presence of toluene and a polymerization catalyst comprising copper to form a polymerization reaction mixture comprising a poly(arylene ether), toluene, copper, and water; separating water from the polymerization reaction mixture to form a solution comprising poly(arylene ether), toluene, and copper; combining (meth)acrylic anhydride with the solution comprising poly(arylene ether), toluene, and copper, and reacting the (meth)acrylic anhydride and the poly(arylene ether) to form a capping reaction mixture comprising a (meth)acrylate-capped poly(arylene ether), toluene, and copper; combining an aqueous chelant solution with the capping reaction mixture; wherein the aqueous chelant solution comprises an alkali metal salt of nitrilotriacetic acid; separating the combined aqueous chelant solution and capping reaction mixture to yield a purified solution and an aqueous phase; wherein the purified solution comprises (meth)acrylate-capped poly(arylene ether) and toluene; and wherein the aqueous phase comprises chelant and copper; precipitating the (meth)acrylate-capped poly(arylene ether) from the purified solution; dissolving the precipitated (meth)acrylate-capped poly(arylene ether) in toluene to form a (meth)acrylate-capped poly(arylene ether) solution; removing toluene from the (meth)acrylate-capped poly(arylene ether) solution to yield a concentrated purified solution; and isolating the (meth)acrylate-capped poly(arylene ether) from the concentrated (meth)acrylate-capped poly(arylene ether) solution; wherein the isolated (meth)acrylate-capped poly(arylene ether) comprises about 0.1 to about 1 part per million by weight of copper.

Another embodiment is a method of removing metal ions from a capped poly(arylene ether) resin, comprising: combining a chelant, water, and a solution comprising a capped poly(arylene ether), a metal ion, and solvent; and separating the combined chelant, water, and solution to form a purified solution and an aqueous phase; wherein the purified solution comprises capped poly(arylene ether) and solvent; and wherein the aqueous phase comprises chelant and metal ion.

Another embodiment is a capped poly(arylene ether) prepared by a method comprising oxidative polymerization of a monohydric phenol in the presence of a catalyst comprising a catalyst metal, wherein the capped poly(arylene ether) comprises less than or equal to 2 parts per million by weight of the catalyst metal.

Another embodiment is a capped poly(arylene ether) having the structure

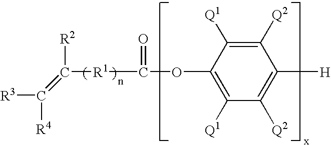

wherein each occurrence of Q¹ is independently halogen, unsubstitited or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; x is 1 to about 40; R¹ is C₁-C₁₂ hydrocarbylene; n is 0 or 1; and R² and R³ and R⁴ are each independently hydrogen or C₁-C₁₈ hydrocarbyl; wherein the capped poly(arylene ether) has an intrinsic viscosity of about 0.03 to about 0.20 deciliter per gram, measured at 25° C. in chloroform; wherein the capped poly(arylene ether) is synthesized by a method comprising oxidative polymerization of a monohydric phenol in the presence of a catalyst comprising a catalyst metal; and wherein the capped poly(arylene ether) comprises less than or equal to 2 parts per million by weight of catalyst metal.

Another embodiment is a capped poly(arylene ether) having the structure

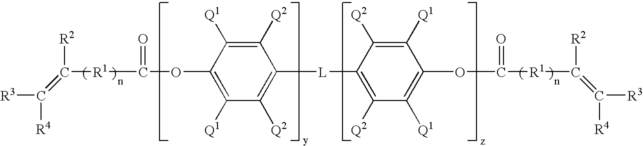

wherein each occurrence of Q¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of y and z is independently 0 to about 100 with the proviso that the sum of y and z is 2 to about 100; each occurrence of R¹ is independently C₁-C₁₂ hydrocarbylene; each occurrence of n is independently 0 or 1; each occurrence of R²-R⁴ is independently hydrogen or C₁-C₁₈ hydrocarbyl; and L has the structure

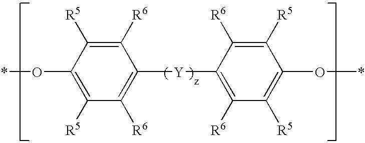

wherein each occurrence of R⁵ and R⁶ is independently selected from the group consisting of hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; z is 0 or 1; and Y has a structure selected from the group consisting of

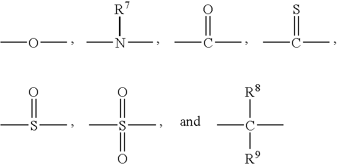

wherein each occurrence of R⁷ is independently selected from the group consisting of hydrogen and C₁-C₁₂ hydrocarbyl, and each occurrence of R⁸ and R⁹ is independently selected from the group consisting of hydrogen, C₁-C₁₂ hydrocarbyl, and C₁-C₆ hydrocarbylene wherein R⁸ and R⁹ collectively form a C₄-C₁₂ alkylene group; wherein the capped poly(arylene ether) has an intrinsic viscosity of about 0.03 to about 0.20 deciliter per gram, measured at 25° C. in chloroform; wherein the capped poly(arylene ether) is synthesized by a method comprising oxidative polymerization of a monohydric phenol and a dihydric phenol in the presence of a catalyst comprising a catalyst metal; and wherein the capped poly(arylene ether) comprises less than or equal to 2 parts per million by weight of catalyst metal.

Additional embodiments, including poly(arylene ether)s prepared by the above methods, are described in detail below.

### DETAILED DESCRIPTION OF THE INVENTION

In the course of their research on improved processes for the synthesis of capped poly(arylene ether)s, the present inventors have discovered that the residual catalyst metal concentration of a capped poly(arylene ether) can be substantially and unexpectedly reduced by performing the catalyst metal chelation step after the poly(arylene ether) is capped. As demonstrated in the working examples below, at least five-fold reductions in catalyst metal concentration have been achieved, and absolute concentrations of residual catalyst metal less than or equal to 2 parts per million by weight are observed. Throughout this document, when a metal concentration is expressed in parts per million by weight, the weight basis is the weight of the isolated, dried, capped poly(arylene ether) in which the metal is detected. In some embodiments, it is possible to achieve concentrations of residual catalyst metal less than 1 part per million by weight, or even less than 0.5 part per million by weight. This achievement is particularly unexpected given that the capping of a poly(arylene ether) represents a relatively small perturbation of the polymer structure as a whole.

One embodiment is a method of preparing a capped poly(arylene ether) resin, comprising: oxidatively polymerizing a phenolic monomer in the presence of a solvent and a catalyst metal to form a polymerization reaction mixture comprising a poly(arylene ether), solvent, catalyst metal, and water; separating water from the polymerization reaction mixture to form a solution comprising poly(arylene ether), solvent, and catalyst metal; combining a capping agent with the solution comprising poly(arylene ether), solvent, and catalyst metal, and reacting the poly(arylene ether) and the capping agent to form a capping reaction mixture comprising a capped poly(arylene ether), solvent, and catalyst metal; combining a chelant with the capping reaction mixture; and separating the combined chelant and capping reaction mixture to yield a purified solution and an aqueous phase; wherein the purified solution comprises capped poly(arylene ether) and solvent; and wherein the aqueous phase comprises chelant and catalyst metal. One step of the method is oxidatively polymerizing a phenolic monomer in the presence of a solvent and a catalyst metal to form a polymerization reaction mixture comprising a poly(arylene ether), solvent, catalyst metal, and water. Suitable phenolic monomers include monohydric phenols, dihydric phenols, polyhydric phenols, and combinations thereof.

A monohydric phenol has one hydroxy group bound directly to an aromatic ring. Suitable monohydric phenols includes those phenol having the structure

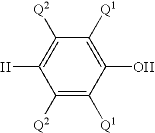

wherein each occurrence of Q¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. The hydrocarbyl residue, when so stated however, can contain heteroatoms over and above the carbon and hydrogen members of the substituent residue. Thus, when specifically noted as containing such heteroatoms, the hydrocarbyl residue can also contain one or more carbonyl groups, amino groups, hydroxyl groups, or the like, or it can contain heteroatoms within the backbone of the hydrocarbyl residue. In some embodiments, the monohydric phenol is 2,6-dimethylphenol, 2,6-diphenylphenol, 2-methylphenol, 2,5-dimethylphenol, 2,3,6-trimethylphenol, or a combination thereof.

A dihydric phenol has two hydroxy groups bound directly to the same aromatic ring or to two different aromatic rings within the same molecule. Suitable dihydric phenols include those having the structure

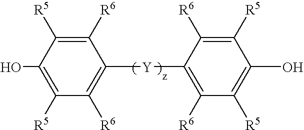

wherein each occurrence of R⁵ and R⁶ is independently selected from the group consisting of hydrogen, halogen, unsubstitited or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; z is 0 or 1; and Y has a structure selected from the group consisting of

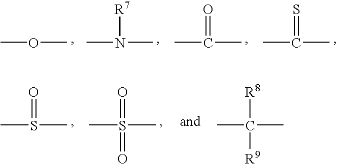

wherein each occurrence of R⁷ is independently selected from the group consisting of hydrogen and C₁-C₁₂ hydrocarbyl, and each occurrence of R⁸ and R⁹ is independently selected from the group consisting of hydrogen, C₁-C₁₂ hydrocarbyl, and C₁-C₆ hydrocarbylene wherein R⁸ and R⁹ collectively form a C₄-C₁₂ alkylene group. In some embodiments, the dihydric phenol is 3,3′,5,5′-tetramethyl-4,4′-biphenol, 2,2-bis(3-methyl-4-hydroxyphenyl)propane, 2,2-bis(3,5-dimethyl-4-hydroxyphenyl)propane, 1,1-bis(4-hydroxyphenyl)methane, 1,1 -bis(4-hydroxyphenyl)ethane, 2,2-bis(4-hydroxyphenyl)propane 2,2-bis(4-hydroxyphenyl)butane, 2,2-bis(4-hydroxyphenyl)octane, 1,1 -bis(4-hydroxyphenyl)propane, 1,1-bis(4-hydroxyphenyl)-n-butane, bis(4-hydroxyphenyl)phenylmethane, 2,2-bis(4-hydroxy-3-methylphenyl)propane, 1,1-bis(4-hydroxy-3-methylphenyl)cyclohexane, 1,1-bis(4-hydroxy-3,5-dimethylphenyl)cyclopentane, 1,1-bis(4-hydroxy-3,5-dimethylphenyl)cyclohexane, 1,1-bis(4-hydroxy-3-methylphenyl)cycloheptane, 1,1-bis(4-hydroxy-3,5-dimethylphenyl)cycloheptane, 1,1-bis(4-hydroxy-3-methylphenyl)cyclooctane, 1,1-bis(4-hydroxy-3,5-dimethylphenyl)cyclooctane, 1,1-bis(4-hydroxy-3-methylphenyl)cyclononane, 1,1-bis(4-hydroxy-3,5-dimethylphenyl)cyclononane, 1,1-bis(4-hydroxy-3-methylphenyl)cyclodecane, 1,1-bis(4-hydroxy-3,5-dimethylphenyl)cyclodecane, 1,1-bis(4-hydroxy-3-methylphenyl)cycloundecane, 1,1-bis(4-hydroxy-3,5-dimethylphenyl)cycloundecane, 1,1-bis(4-hydroxy-3-methylphenyl)cyclododecane, 1,1-bis(4-hydroxy-3,5-dimethylphenyl)cyclododecane, 1,1-bis(4-hydroxy-3-t-butylphenyl)propane, 2,2-bis(4-hydroxy-2,6-dimethylphenyl)propane 2,2-bis(4-hydroxy-3-bromophenyl)propane, 1,1-bis(4-hydroxyphenyl)cyclopentane, 1,1-bis(4-hydroxyphenyl)cyclohexane, or a combination thereof. In some embodiments, the phenolic monomer consists of a monohydric phenol and a dihydric phenol.

A polyhydric phenol has three or more hydroxy groups bound directly to the same aromatic ring or to different aromatic rings within the same molecule. In some embodiments, the polyhydric phenol comprises 3 to about 8 phenolic hydroxy groups. Suitable polyhydric phenols include 1,1,1-tris(3,5-dimethyl-4-hydroxyphenyl)ethane 1,1,1-tris(3-methyl-4-hydroxyphenyl)ethane, 1,3,5-tris(3,5-dimethyl-4-hydroxyphenyl-1-keto)benzene, 1,3,5-tris(3,5-dimethyl-4hydroxyphenyl-1-isopropylidene)benzene, 2,2,4,4-tetrakis(3-methyl-4hydroxyphenyl)pentane, 2,2,4,4-tetrakis(3,5-dimethyl-4-hydroxyphenyl)pentane, 1,1,4,4-tetrakis(3-methyl-4-hydroxyphenyl)cyclohexane, 1,1,4,4-tetrakis(3,5-dimethyl-4-hydroxyphenyl)cyclohexane, 1,3,5-tris(3,5-dimethyl-4-hydroxyphenyl)benzene, 1,3,5-tris(3-methyl-4-hydroxyphenyl)benzene, 2,6-bis(2-hydroxy-5-methylbenzyl)-4-methyl phenol, 4,6-dimethyl-2,4,6-tris(4-hydroxy-3-methylphenyl)-2-heptene, 4,6-dimethyl-2,4,6-tris(4-hydroxy-3,5-dimethylphenyl)-2-heptene, 4,6-dimethyl-2,4,6-tris(4-hydroxy-3-methylphenyl)heptane, 4,6-dimethyl-2,4,6-tris(4-hydroxy-3-methylphenyl)heptane, 2,4-bis(4-hydroxy-3-methylphenylisopropyl)phenol, 2,4-bis(4-hydroxy-3,5-dimethylphenylisopropyl)phenol, tetrakis(4-hydroxy-3-methylphenyl)methane, tetrakis(4-hydroxy-3,5-dimethylphenyl)methane, tetrakis(4-[4-hydroxy-3-methylphenylisopropyl]-phenoxy)methane, tetrakis(4-[4-hydroxy-3,5-dimethylphenylisopropyl]-phenoxy)methane, and combinations thereof.

The phenolic monomer is oxidatively polymerized in the presence of a solvent. Suitable solvents include, for example, halogenated aliphatic hydrocarbon solvents, aromatic hydrocarbon solvents, halogenated aromatic hydrocarbon solvents, and combinations thereof. Specific examples of halogenated aliphatic hydrocarbon solvents include trichloromethane (chloroform), tetrachloromethane (carbon tetrachloride), dichloroethanes, dichloroethylenes, trichloroethanes, trichloroethylene, tetrachloroethanes, pentachloroethane, hexachloroethane, tribromomethane, dibromoethanes, and combinations thereof. Specific examples of aromatic hydrocarbon solvents include benzene, toluene, ethylbenzene, xylenes, and combinations thereof. Specific examples of halogenated aromatic hydrocarbon solvents include chlorobenzene, dichlorobenzenes, and trichlorobenzenes, and combinations thereof. In some embodiments, the solvent is toluene.

Oxidative polymerization of the phenolic monomer is conducted in the presence of a catalyst metal. The catalyst metal can be any metal that is effective to catalyze the oxidative polymerization of phenols. Suitable catalyst metals include copper, manganese, cobalt, and mixtures thereof. In some embodiments, the catalyst metal is copper. Within a polymerization reaction mixture, a capping reaction mixture, or any of the other solutions described herein, a catalyst metal is typically present in oxidized (cationic) form. For example, when the catalyst metal is copper, the polymerization reaction mixture can comprise the catalyst metal in the form of an amine complex of Cu⁺ or Cu²⁺. Amines used to form metal complex catalysts for oxidative polymerization are known in the art and include, for example, alkylenediamine ligands (such as N,N′-di-t-butylethylenediamine and N,N,N′,N′-tetramethyl-1,3-diaminopropane), primary monoamines (such as n-butylamine), secondary monoamines (such as di-n-butylamine), tertiary monoamines (such as dimethyl-n-butylamine), aminoalcohols (such as triethanolamine and N-phenyl-ethanolamine), oximes (such as benzoin oxime (2-Hydroxy-2-phenylacetophenone oxime), 2-phenyl-2-hydroxybutan-3-one oxime, and 2-salicyl-aldoxime), oxines (such as oxine and 5-methyloxine), and the like. After polymerization of the phenolic monomer has been conducted to the desired extent, the reaction mixture is designated a polymerization reaction mixture. The polymerization reaction mixture comprises a poly(arylene ether), solvent, catalyst metal, and water.

In addition to the oxidative polymerization step, the method comprises separating water from the polymerization reaction mixture to form a solution comprising poly(arylene ether), solvent, and catalyst metal. Separating water from the reaction mixture helps separate the poly(arylene ether) from water-soluble reaction components, and it also reduces unwanted hydrolysis of capping agent used in the subsequent capping step. Methods capable of separating water from an organic solution are known in the art and include, for example, of liquid-liquid centrifugation, azeotropic distillation, adsorption (for example, adsorption to molecular sieves), diffusion through a membrane, and combinations thereof.

In addition to the oxidative polymerization and water separation steps, the method comprises combining a capping agent with the solution comprising poly(arylene ether), solvent, and catalyst metal, and reacting the poly(arylene ether) and the capping agent to form a capping reaction mixture comprising a capped poly(arylene ether), solvent, and catalyst metal. Capping agents capable of reacting with the free hydroxy groups of the poly(arylene ether) are known in the art and described, for example, in U.S. Pat. No. 3,375,228 to Holoch et al., U.S. Pat. No. 6,352,782 to Yeager et al., and U.S. Pat. No. 6,384,176 to Braat et al. Suitable capping agents include those having the structure

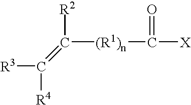

wherein each occurrence of R¹ is C₁-C₁₂ hydrocarbylene; each occurrence of R² is independently hydrogen or methyl; each occurrence of R³ and R⁴ are independently hydrogen or C₁-C₁₂ hydrocarbyl; n is 0 or 1; and X is selected from the group consisting of

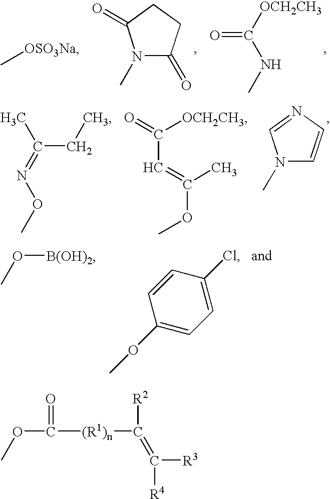

wherein R¹, R², R³, R⁴, and n are defined as above. In some embodiments, the capping agent is (meth)acrylic anhydride. As use herein, the prefix (meth)acryl- includes acryl-, methacryl- and combinations thereof. For example, when it is stated that the capping agent is (meth)acrylic anhydride, the capping agent can be acrylic anhydride, methacrylic anhydride, a mixed anhydride, or a combination of two or more of the foregoing anhydrides. In some embodiments, the capping agent is methacrylic anhydride.

Conditions suitable for reacting the poly(arylene ether) and the capping agent to form a capped poly(arylene ether) will vary according to factors including the identity of the capping agent, the concentration of the capping agent, the identity of the poly(arylene ether), the concentration of the poly(arylene ether), and the identity of the solvent. Those skilled in the art can select reaction conditions without undue experimentation. Reaction conditions suitable for methacrylate capping of poly(arylene ether)s are described in the working examples below. In some embodiments, reacting the poly(arylene ether) and the capping agent is conducted in the presence of a capping catalyst. Suitable capping catalysts include, for example, dialkylaminopyridines, pyrrolidinopyridines, and combinations thereof. In some embodiments, the capping catalyst is 4-dimethylaminopyridine.

In addition to the oxidative polymerization, water separation, and capping steps, the method comprises combining a chelant with the capping reaction mixture and separating the combined chelant and capping reaction mixture to yield a purified solution and an aqueous phase, wherein the purified solution comprises capped poly(arylene ether) and solvent, and wherein the aqueous phase comprises chelant and catalyst metal. In this context, it will be understood that the aqueous phase can comprise the chelant and the catalyst metal at least in part as a chelated metal complex. The chelant can be any material that binds the catalyst metal and facilitates its separation from the capping reaction mixture. Suitable classes of chelants include, for example, polyalkylenepolyamine polycarboxylic acids, aminopolycarboxylic acids, aminocarboxylic acids, polycarboxylic acids, alkali metal salts of the foregoing acids, alkaline earth metal salts of the foregoing acids, mixed alkali metal-alkaline earth metal salts of the foregoing acids, and combinations thereof. Specific suitable chelants include, for example, hydroxyethylethylenediaminetriacetic acid, diethylenetriaminepentaacetic acid, nitrilotriacetic acid, ethylenediaminetetraacetic acid, alkali metal salts of the foregoing acids, alkaline earth metal salts of the foregoing acids, and combinations thereof. In some embodiments, the chelant comprises an alkali metal salt of nitrilotriacetic acid. In order to facilitate contact of the chelant with the catalyst metal and also to facilitate separation of the chelated catalyst metal, the chelant can be provided in the form of an aqueous chelant solution when the chelant is combined with the capping reaction mixture. For example, an aqueous solution can comprise about 5 to about 70 weight percent chelant, specifically about 15 to about 60 weight percent chelant, more specifically about 25 to about 50 weight percent chelant. Alternatively, chelant and water can be separately combined with the capping reaction mixture. The amount of the chelant can be any amount effective to bind the catalyst metal. For example, when the chelant is an alkali metal salt of nitrilotriacetic acid, the chelant can be used in an amount of about 1 to about 15 moles of chelant per mole of catalyst metal, specifically about 1.1 to about 10 moles of chelant per mole of catalyst metal, more specifically about 1.1 to about 5 moles of chelant per mole of catalyst metal, even more specifically about 1.1 to about 2 moles of chelant per mole of catalyst metal, yet more specifically about 1.1 to about 1.5 moles of chelant per mole of catalyst metal, still more specifically about 1.1 to about 1.3 moles of chelant per mole of catalyst metal.

After contacting the capping reaction mixture with chelant, the combined chelant and capping reaction mixture are separated to yield a purified solution and an aqueous phase, wherein the purified solution comprises capped poly(arylene ether) and solvent, and wherein the aqueous phase comprises chelant and catalyst metal. Methods effective for performing this separation include, for example, liquid-liquid centrifuge, decantation, and combinations thereof. The water content of the aqueous phase can be derived from residual water in the solution comprising poly(arylene ether) and solvent and catalyst metal, or water in an aqueous chelant solution, among other possible sources of water.

The concentrations of the poly(arylene ether) in the polymerization reaction mixture, the solution comprising poly(arylene ether) and solvent and catalyst metal, the capping reaction mixture, and the purified solution can each independently be about 10 to about 80 weight percent, specifically about 20 to about 70 weight percent, more specifically about 30 to about 60 weight percent, even more specifically about 40 to about 55 weight percent, still more specifically about 40 to about 50 weight percent. The concentration of the poly(arylene ether) in any of these mixtures may, optionally, be reduced by diluting the mixture or increased by concentrating the mixture. For example, the method may, optionally, comprise removing solvent from the polymerization reaction mixture, or the solution comprising poly(arylene ether) and solvent and catalyst metal, or the capping reaction mixture, or the purified solution. As used herein, the word “removing” means at least partially removing. Typically, only a fraction of the solvent is removed. Solvent can be removed, for example, by distillation at atmospheric or sub-atmospheric pressure. As another example, the concentration of poly(arylene ether) in the capping reaction mixture may, optionally, be reduced by addition of solvent before the capping reaction mixture is combined with the chelant.

In addition to the polymerization step, the water removal step, the capping step, the chelation step, and the chelant separation step, the method may, optionally, further comprise isolating the capped poly(arylene ether). The capped poly(arylene ether) can be isolated from the purified solution, before or after optional addition or removal of solvent from that solution. Methods for isolating poly(arylene ether)s from solution are known in the art and include, for example, precipitation, devolatilizing extrusion, spray drying, wiped film evaporation, flake evaporation, and combinations of the foregoing methods.

An important advantage of the present method is that isolated capped poly(arylene ether)s prepared by the method have substantially and unexpectedly lower catalyst metal concentrations than capped poly(arylene ether)s prepared by other methods. For example, in some embodiments, the isolated capped poly(arylene ether) comprises a catalyst metal concentration of less than or equal to 2 parts per million by weight. In some embodiments, the isolated capped poly(arylene ether) comprises a catalyst metal concentration of about 0.1 to 2 parts per million by weight, specifically about 0.2 to about 1.5 parts per million by weight, more specifically about 0.1 to about 1 part per million by weight, even more specifically about 0.2 to about 0.8 part per million by weight, yet more specifically about 0.2 to about 0.6 parts per million by weight. Analytical techniques capable of detecting low concentrations of catalyst metals are known in the art and include, for example, inductively coupled plasma-optical emission spectrometry (ICP-OES).

One embodiment is a method of preparing a capped poly(arylene ether) resin comprising: oxidatively polymerizing 2,6-dimethylphenol in the presence of toluene and a polymerization catalyst comprising copper to form a polymerization reaction mixture comprising a poly(arylene ether), toluene, copper, and water; separating water from the polymerization reaction mixture to form a solution comprising poly(arylene ether), toluene, and copper; combining (meth)acrylic anhydride with the solution comprising poly(arylene ether), toluene, and copper, and reacting the (meth)acrylic anhydride and the poly(arylene ether) to form a capping reaction mixture comprising a (meth)acrylate-capped poly(arylene ether), toluene, and copper; combining an aqueous chelant solution with the capping reaction mixture; wherein the aqueous chelant solution comprises an alkali metal salt of nitrilotriacetic acid; separating the combined aqueous chelant solution and capping reaction mixture to yield a purified solution and an aqueous phase; wherein the purified solution comprises (meth)acrylate-capped poly(arylene ether) and toluene; and wherein the aqueous phase comprises chelant and copper; and isolating the (meth)acrylate-capped poly(arylene ether); wherein the isolated (meth)acrylate-capped poly(arylene ether) comprises about 0.1 to about 1 part per million by weight of copper. In this embodiment, isolating the (meth)acrylate-capped poly(arylene ether) can be conducted with or without first concentrating the purified solution.

One embodiment is a method of preparing a capped poly(arylene ether) resin comprising: oxidatively polymerizing 2,6-dimethylphenol in the presence of toluene and a polymerization catalyst comprising copper to form a polymerization reaction mixture comprising a poly(arylene ether), toluene, copper, and water; separating water from the polymerization reaction mixture to form a solution comprising poly(arylene ether), toluene, and copper; removing toluene from the polymerization reaction mixture or the solution comprising poly(arylene ether), toluene, and copper; combining (meth)acrylic anhydride with the solution comprising poly(arylene ether), toluene, and copper, and reacting the (meth)acrylic anhydride and the poly(arylene ether) to form a capping reaction mixture comprising a (meth)acrylate-capped poly(arylene ether), toluene, and copper; adding toluene to the capping reaction mixture to form a diluted capping reaction mixture; combining an aqueous chelant solution with the diluted capping reaction mixture; wherein the aqueous chelant solution comprises an alkali metal salt of nitrilotriacetic acid; separating the combined aqueous chelant solution and diluted capping reaction mixture to yield a purified solution and an aqueous phase; wherein the purified solution comprises (meth)acrylate-capped poly(arylene ether) and toluene; and wherein the aqueous phase comprises chelant and copper; removing toluene from the purified solution to yield a concentrated purified solution; and isolating the (meth)acrylate-capped poly(arylene ether) from the concentrated purified solution; wherein the isolated (meth)acrylate-capped poly(arylene ether) comprises about 0.1 to about 1 part per million by weight of copper. It is possible to combine the water separation and toluene removal steps in a single azeotropic distillation step. Adding toluene to the capping reaction mixture has been observed to improve the efficiency of both catalyst metal chelation and subsequent separation of the combined aqueous chelant solution and diluted capping reaction mixture.

One embodiment is a method of preparing a capped poly(arylene ether) resin comprising: oxidatively polymerizing 2,6-dimethylphenol in the presence of toluene and a polymerization catalyst comprising copper to form a polymerization reaction mixture comprising a poly(arylene ether), toluene, copper, and water; separating water from the polymerization reaction mixture to form a solution comprising poly(arylene ether), toluene, and copper; combining (meth)acrylic anhydride with the solution comprising poly(arylene ether), toluene, and copper, and reacting the (meth)acrylic anhydride and the poly(arylene ether) to form a capping reaction mixture comprising a (meth)acrylate-capped poly(arylene ether), toluene, and copper; combining an aqueous chelant solution with the capping reaction mixture; wherein the aqueous chelant solution comprises an alkali metal salt of nitrilotriacetic acid; separating the combined aqueous chelant solution and capping reaction mixture to yield a purified solution and an aqueous phase; wherein the purified solution comprises (meth)acrylate-capped poly(arylene ether) and toluene; and wherein the aqueous phase comprises chelant and copper; precipitating the (meth)acrylate-capped poly(arylene ether) from the purified solution; dissolving the precipitated (meth)acrylate-capped poly(arylene ether) in toluene to form a (meth)acrylate-capped poly(arylene ether) solution; removing toluene from the purified solution to yield a concentrated purified solution; and isolating the (meth)acrylate-capped poly(arylene ether) from the concentrated purified solution; wherein the isolated (meth)acrylate-capped poly(arylene ether) comprises about 0.1 to about 1 part per million by weight of copper. The step of dissolving the precipitated (meth)acrylate-capped poly(arylene ether) can be conducted on the so-called “wet cake” of (meth)acrylate-capped poly(arylene ether) produced by filtering the precipitate. In other words, the precipitated of (meth)acrylate-capped poly(arylene ether) need not be freed of residual solvent and antisolvent before it is redissolved in toluene.

The method need not include an oxidative polymerization step. Also, the method is generally effective to reduce metal ion impurities in a capped poly(arylene ether), including metal ion impurities that are not associated with a catalyst metal for oxidative polymerization. Thus, one embodiment is a method of removing metal ions from a capped poly(arylene ether) resin, comprising: combining a chelant, water, and a solution comprising a capped poly(arylene ether), a metal ion (present as an impurity in the capped poly(arylene ether)), and solvent; and separating the combined chelant, water, and solution to form a purified solution and an aqueous phase; wherein the purified solution comprises capped poly(arylene ether) and solvent; and wherein the aqueous phase comprises chelant and metal ion. The capped poly(arylene ether) and the chelant can be any of those described herein. The solvent can be any of the solvents described above in the context of oxidative polymerization. The method of separating the combined chelant, water, and solution, can be any of the methods described above in the context of separating the combined chelant and capping reaction mixture. In this embodiment, the chelant and water can be provided separately. Alternatively, the chelant and water can be provided together in the form of an aqueous chelant solution. Also, a portion of the water can be provided as a component of an aqueous chelant solution, and additional water can be added separately. Subsequent isolation of the capped poly(arylene ether), for example, from the purified solution, can yield an isolated capped poly(arylene ether) comprises less than or equal to 2 parts per million by weight of metal ion, specifically about 0.1 to 2 parts per million by weight of catalyst metal ion.

The invention extends to capped poly(arylene ether)s produced by the methods described above. These capped poly(arylene ether)s are distinguished from previously known capped poly(arylene ether)s by their exceptionally low levels of residual catalyst metal. One embodiment is a capped poly(arylene ether) prepared by a method comprising oxidative polymerization of a monohydric phenol in the presence of a catalyst comprising a catalyst metal, wherein the capped poly(arylene ether) comprises less than or equal to 2 parts per million by weight of the catalyst metal. In some embodiments, the catalyst metal concentration in the capped poly(arylene ether) is about 0.1 to 2 parts per million by weight, specifically about 0.1 to about 1.5 parts per million by weight, more specifically about 0.1 to about 1 part per million by weight, even more specifically about 0.2 to about 1 part per million by weight, yet more specifically about 0.2 to about 0.8 part per million by weight, even more specifically about 0.2 to about 0.6 parts per million by weight.

One embodiment is a capped poly(arylene ether) having the structure

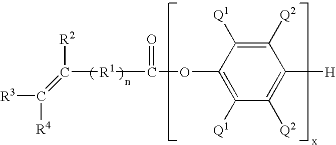

wherein each occurrence of Q¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; x is 1 to about 40, specifically 1 to about 30, more specifically 1 to about 20, even more specifically 1 to about 10; R¹ is C₁-C₁₂ hydrocarbylene; n is 0 or 1; and R² and R³ and R⁴ are each independently hydrogen or C₁-C₁₈ hydrocarbyl; wherein the capped poly(arylene ether) has an intrinsic viscosity of about 0.03 to about 0.20 deciliter per gram, specifically about 0.06 to about 0.15 deciliter per gram, more specifically about 0.06 to about 0.12 deciliter per gram, even more specifically about 0.06 to about 0.09 deciliter per gram, measured at 25° C. in chloroform; wherein the capped poly(arylene ether) is synthesized by a method comprising oxidative polymerization of a monohydric phenol in the presence of a catalyst comprising a catalyst metal; and wherein the capped poly(arylene ether) comprises less than or equal to 2 parts per million by weight of catalyst metal. In some embodiments, the catalyst metal concentration in the capped poly(arylene ether) is about 0.1 to 2 parts per million by weight, specifically about 0.1 to about 1.5 parts per million by weight, more specifically about 0.1 to about 1 part per million by weight, even more specifically about 0.2 to about 1 part per million by weight, yet more specifically about 0.2 to about 0.8 part per million by weight, even more specifically about 0.2 to about 0.6 parts per million by weight.

One embodiment is a capped poly(arylene ether) having the structure

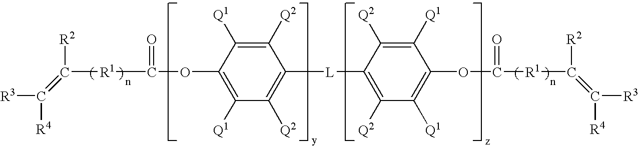

wherein each occurrence of Q¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of y and z is independently 0 to about 100 with the proviso that the sum of y and z is 2 to about 100; each occurrence of R¹ is independently C₁-C₁₂ hydrocarbylene; each occurrence of n is independently 0 or 1; each occurrence of R²-R⁴ is independently hydrogen or C₁-C₁₈ hydrocarbyl; and L has the structure

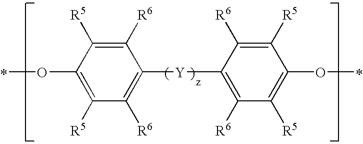

wherein each occurrence of R⁵ and R⁶ is independently selected from the group consisting of hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; z is 0 or 1; and Y has a structure selected from the group consisting of

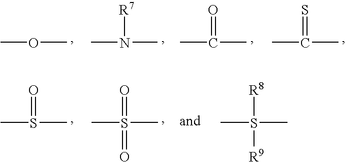

wherein each occurrence of R⁷ is independently selected from the group consisting of hydrogen and C₁-C₁₂ hydrocarbyl, and each occurrence of R⁸ and R⁹ is independently selected from the group consisting of hydrogen, C₁-C₁₂ hydrocarbyl, and C₁-C₆ hydrocarbylene wherein R⁸ and R⁹ collectively form a C₄-C₁₂ alkylene group; wherein the capped poly(arylene ether) has an intrinsic viscosity of about 0.03 to about 0.20 deciliter per gram, specifically about 0.06 to about 0.15 deciliter per gram, more specifically about 0.06 to about 0.12 deciliter per gram, even more specifically about 0.06 to about 0.09 deciliter per gram, measured at 25° C. in chloroform; wherein the capped poly(arylene ether) is synthesized by a method comprising oxidative polymerization of a monohydric phenol and a dihydric phenol in the presence of a catalyst comprising a catalyst metal; and wherein the capped poly(arylene ether) comprises less than or equal to 2 parts per million by weight of catalyst metal. In some embodiments, the catalyst metal concentration in the capped poly(arylene ether) is about 0.1 to 2 parts per million by weight, specifically about 0.1 to about 1.5 parts per million by weight, more specifically about 0.1 to about 1 part per million by weight, even more specifically about 0.2 to about 1 part per million by weight, yet more specifically about 0.2 to about 0.8 part per million by weight, even more specifically about 0.2 to about 0.6 parts per million by weight.

One embodiment is a capped poly(arylene ether) having the structure

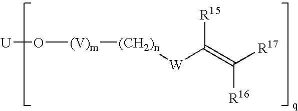

wherein U is a C₆-C₁₈ aryl group optionally substituted with one or more C₁-C₆ alkyl groups; V is a phenylene ether group; m is 1 to about 100; n is 0 to 6; W is a phenylene group or an oxygen atom; each occurrence of R¹⁵, R¹⁶, and R¹⁷ is independently selected from the group consisting of hydrogen, C₁-C₆ alkyl, C₂-C₆ alkenyl, and C₂-C₆ alkynyl; and q is 1 to 4; wherein the capped poly(arylene ether) comprises less than or equal to 2 parts per million by weight of catalyst metal. In some embodiments, the capped poly(arylene ether) comprises about 0.2 to about 1 part per million by weight of the catalyst metal. Procedures for synthesizing capped poly(arylene ether)s having this structure are described in U.S. Patent No. US 2004/0146692 A1 to Inoue et al.

The invention extends to curable compositions comprising the capped poly(arylene ether)s with low residual catalyst metal concentrations. In addition to the capped poly(arylene ether), the curable composition comprises a thermoset resin. In some embodiments, the thermoset resin comprises a functional group that is copolymerizable with a capping group on the capped poly(arylene ether). The functional group can be, for example, an aliphatic carbon-carbon double bond. Such copolymerizable thermoset resins include, for example, alkenyl aromatic monomers, allylic monomers, acryloyl monomers, vinyl ethers, maleimides, and mixtures thereof.

Suitable alkenyl aromatic monomers include those having the formula

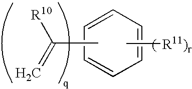

wherein each occurrence of R¹⁰ is independently hydrogen or C₁-C₁₈ hydrocarbyl; each occurrence of R¹¹ is independently halogen, C₁-C₁₂ alkyl, C₁-C₁₂ alkoxyl, or C₆-C₁₈ aryl; q is 1 to 4; and r is 0 to 5. Unspecified positions on the aromatic ring are substituted with hydrogen atoms. Specific suitable alkenyl aromatic monomers include, for example, styrene, α-methylstyrene, 2-methylstyrene, 3-methylstyrene, 4-methylstyrene, 2-t-butylstyrene, 3-t-butylstyrene, 4-t-butylstyrene, 1,3-divinylbenzene, 1,4-divinylbenzene, 1,3-diisopropenylbenzene, 1,4-diisopropenylbenzene, styrenes having from 1 to 5 halogen substituents on the aromatic ring, and the like, and combinations thereof. In some embodiments, the alkenyl aromatic monomer is styrene.

The curable composition can comprise an allylic monomer. An allylic monomer is an organic compound comprising at least one, preferably at least two, more preferably at least three allyl (—CH₂—CH═CH₂) groups. Suitable allylic monomers include, for example, diallyl phthalate, diallyl isophthalate, triallyl mellitate, triallyl mesate, triallyl benzenes, triallyl cyanurate, triallyl isocyanurate, mixtures thereof, partial polymerization products prepared therefrom, and the like.

The curable composition can comprise an acryloyl monomer. An acryloyl monomer is a compound comprising at least one acryloyl moiety having the structure

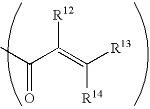

wherein R¹², R¹³, and R¹⁴ are each independently hydrogen, C₁-C₁₂ hydrocarbyl, C₂-C₁₈ hydrocarbyloxycarbonyl, nitrile, formyl, carboxylic acid, imidate, thiocarboxylic acid, or the like. In one embodiment, the acryloyl monomer comprises at least two acryloyl moieties. In another embodiment, the acryloyl monomer comprises at least three acryloyl moieties. Suitable acryloyl monomers include, for example, trimethylolpropane tri(meth)acrylate, 1,6-hexanediol di(meth)acrylate, neopentyl glycol di(meth)acrylate, ethylene glycol di(meth)acrylate, propylene glycol di(meth)acrylate, cyclohexanedimethanol di(meth)acrylate, butanediol di(meth)acrylate, diethylene glycol di(meth)acrylate, methylene glycol di(meth)acrylate, isobornyl(meth)acrylate, methyl(meth)acrylate, methacryloxypropyl trimethoxysilane (also known as 3-(trimethoxysilyl)propyl methacrylate), ethoxylated (2) bisphenol A di(meth)acrylate (it will be understood that the number following the ethoxylated term refers to the average number of ethoxy groups in the ethoxylate chain attached to each oxygen of bisphenol A), and the like, and mixtures comprising at least one of the foregoing acryloyl monomers. Although not strictly meeting the above definition of an acryloyl monomer, unsaturated polyester resins can also be used in the curable composition. Rather than having pendant acryloyl groups, unsaturated polyester resins include in-chain carbon-carbon double bonds adjacent to carbonyl groups

In some embodiment, the curable composition comprises styrene and trimethylolpropane trimethacrylate.

The curable composition can comprise a vinyl ether. Vinyl ethers are compounds comprising at least one moiety having the structure

H₂C═CH—O-*

Suitable vinyl ethers include, for example, 1,2-ethylene glycol divinyl ether, 1,3-propanediol divinyl ether, 1,4-butanediol divinyl ether, triethyleneglycol divinyl ether, 1,4-cyclohexanedimethanol divinyl ether, ethyl vinyl ether, n-butyl vinyl ether, lauryl vinyl ether, 2-chloroethyl vinyl ether, and the like, and mixtures thereof.

The curable composition can comprise a maleimide. A maleimide is a compound comprising at least one moiety having the structure

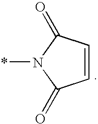

Suitable maleimides include, for example, N-phenylmaleimide, 1,4-phenylene-bis-methylene-α,α′-bismaleimide, 2,2-bis(4-phenoxyphenyl)-N,N′-bismaleimide, N,N′-phenylene bismaleimide, N,N′-hexamethylene bismaleimide, N-N′-diphenyl methane bismaleimide, N,N′-oxy-di-p-phenylene bismaleimide, N,N′-4,4′-benzophenone bismaleimide, N,N′-p-diphenylsulfone bismaleimide, N,N′-(3,3′-dimethyl)methylene-di-p-phenylene bismaleimide, poly(phenylmethylene)polymaleimide, bis(4-phenoxyphenyl). sulfone-N,N′-bismaleinide, 1,4-bis(4-phenoxy)benzene-N,N′-bismaleimide, 1,3-bis(4-phenoxy)benzene-N,N′-bismaleimide, 1,3-bis(3-phenoxy)benzene-N,N′-bismaleimide, and the like, and mixtures thereof.

The thermoset resin need not be copolymerizable with the capped poly(arylene ether) for the curable composition to benefit from addition of the capped poly(arylene ether). Thus, in some embodiments, the thermoset resin can lack functionality that is copolymerizable with the capping group of the capped poly(arylene ether). For example, the thermoset resin can be an epoxy resin. Suitable epoxy resins include, for example diepoxides having the formula

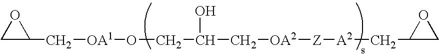

wherein A¹ and A² are C₆-C₁₈ aromatic radicals; Z is a single bond, a C₁-C₁₂ hydrocarbylene radical, oxy, thio, sulfonyl, sulfoxy, or carbonyl; and s is 0 to about 500. The radicals A⁵ and A⁶ can be substituted or unsubstituted with groups such as aryl, alkyl, alkoxy, halogen, and the like.

Common examples of the above diepoxide compounds include diglycidyl ethers often produced by the condensation of epichlorohydrin with a bisphenol where q=0. Typical of this class of compounds are the diglycidyl ethers of 4,4′-(1-methylethylidene) diphenol, 4,4′-(1-methylethylidene)bis(2-methylphenol), 4,4′-(1-methylethylidene)bis(2,6-dimethylphenol), 4,4′-(1,1-cyclopentylidene)diphenol, 4,4′-(cyclohexylidene)diphenol, 4,4′-(1-methylethylidene)bis(2,6-dibromo phenol), 4,4′-methylenediphenol, 4,4′-(1-methylethylidene)bis(2-allylphenol), 4,4′-(1-methylethylidene)bis(2-t-butyl-5-methylphenol), 4,4′-(1-methylethylidene)bis(2-t-butyl-5-methylphenol), 4,4′-(1-methylpropylidene)bis(2-t-butyl-5-ethylphenol), 4,4′-(1,4-bis(methylethylidene)phenyl)bis(2-t-butyl-5-methylphenol), 4,4′-biphenol, hydroquinone, resorcinol, and the like. Oligomeric products generated during this condensation reaction are also known and are useful. Such compounds are exemplified by the oligomeric condensation product of bisphenol A and epichlorohydrin sold by Shell Corporation under the trade name EPON® as EPON® 825 (q=0) and EPON® 828 (q=0.14).

The curable composition can generally comprise about 5 to about 90 parts by weight of the capped poly(arylene ether) and about 10 to about 95 parts by weight of the thermoset resin, both based on 100 parts by weight total of the capped poly(arylene ether) and the thermoset resin. Within the above range, the capped poly(arylene ether) amount can be about 10 to about 80 parts by weight, specifically about 10 to about 60 parts by weight, more specifically about 15 to about 50 parts by weight. Within the above range, the thermoset resin amount can be about 20 to about 90 parts by weight, specifically about 40 to about 90 parts by weight, more specifically about 50 to about 85 parts by weight.

The curable composition may, optionally, further comprise a curing promoter. The type and amount of curing promoter used depends on the type of thermoset resin in the curable composition. Non-limiting examples of curing promoters suitable for use with thermoset resins comprising polymerizable carbon-carbon double bonds include those described in U.S. Pat. No. 5,407,972 to Smith et al., and U.S. Pat. No. 5,218,030 to Katayose et al. These curing promoters can include any compound capable of producing free radicals at elevated temperatures. Such curing promoters can include both peroxy and non-peroxy based radical initiators. Examples of useful peroxy initiators include, for example, benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, α,α′-bis(t-butylperoxy-m-isopropyl)benzene, 2,5-dimethyl-2,5-di(t-butylperoxy)hexane, di(t-butylperoxy)isophthalate, t-butylperoxy benzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, trimethylsilylphenyltriphenylsilyl peroxide, and the like, and mixtures thereof. Suitable non-peroxy initiators include, for example, 2,3-dimethyl-2,3-diphenylbutane, 2,3-trimethylsilyloxy-2,3-diphenylbutane, and the like, and mixtures thereof. The curing promoter can also be a compound capable of initiating anionic polymerization of the thermoset resin. Such anionic polymerization initiators include, for example, alkali metal amides, such as sodium amide (NaNH₂) and lithium diethyl amide (LiN(C₂H₅)₂); alkali metal and ammonium salts of C₁-C₁₀ alkoxides; alkali metal and ammonium hydroxides; alkali metal cyanides; organometallic compounds such as the alkyl lithium compound n-butyl lithium; Grignard reagents such as phenyl magnesium bromide; and the like; and combinations thereof. In some embodiments in which the thermoset resin is copolymerizable with the capped poly(arylene ether), the curing promoter comprises t-butylperoxy benzoate or dicumyl peroxide. The curing promoter can promote curing at a temperature in a range of about 0° C. to about 200° C.

When the thermoset resin is an epoxy resin, the curing promoter can be, for example, a latent cationic cure catalyst or a hardener. Suitable latent cationic cure catalysts include, for example, diaryliodonium salts, phosphonic acid esters, sulfonic acid esters, carboxylic acid esters, phosphonic ylides, benzylsulfonium salts, benzylpyridinium salts, benzylammonium salts, isoxazolium salts, and combinations thereof. Suitable hardeners include, for example, novolac type phenol resins, aralkyl type phenol resins, dicyclopentadiene type phenol resins, telpene modified phenol resins, biphenyl type phenol resins, bisphenols, triphenylmethane type phenol resins, and combinations thereof.

The amount of the curing promoter will depend on factors including the type and amount of capped poly(arylene ether), the type and amount of thermoset resin, and the type of curing promoter. Those skilled in the art can determine a curing promoter amount without undue experimentation.

The curable composition may, optionally, further comprise a curing inhibitor. Suitable curing inhibitors for use with thermoset resins comprising polymerizable carbon-carbon double bonds include, for example, diazoaminobenzene, phenylacetylene, sym-trinitrobenzene, p-benzoquinone, acetaldehyde, aniline condensates, N,N′-dibutyl-o-phenylenediamine, N-butyl-p-aminophenol, 2,4,6-triphenylphenoxyl, pyrogallol, catechol, hydroquinone, monoalkylhydroquinones, p-methoxyphenol, t-butylhydroquinone, C₁-C₆-alkyl-substituted catechols, dialkylhydroquinone, 2,4,6-dichloronitrophenol, halogen-ortho-nitrophenols, alkoxyhydroquinones, mono- and di- and polysulfides of phenols and catechols, thiols, oximes and hydrazones of quinone, phenothiazine, dialkylhydroxylamines, and the like, and combinations thereof. In some embodiments, the curing inhibitor comprises benzoquinone, hydroquinone, 4-t-butylcatechol, or a combination thereof.

When the curing inhibitor is present, it can be used at about 0.005 to about 1 part by weight per 100 parts by weight total of the capped poly(arylene ether) and the thermoset resin. In some embodiments, the curing inhibitor amount is about 0.05 to about 0.5 part by weight, specifically about 0.1 to about 0.3 part by weight.

The curable composition may, optionally, further comprise one or more fillers, including particulate fillers and fibrous fillers. A particulate filler is herein defined as a filler having an average aspect ratio less than about 5:1. Non-limiting examples of fillers include silica powder, such as fused silica and crystalline silica; boron-nitride powder and boron-silicate powders for obtaining cured products having high thermal conductivity, low dielectric constant and low dielectric loss tangent; the above-mentioned powder as well as alumina, and magnesium oxide (or magnesia) for high temperature conductivity; and fillers, such as wollastonite including surface-treated wollastonite, calcium sulfate (in its anhydrous, hemihydrated, dihydrated, or trihydrated forms), calcium carbonate including chalk, limestone, marble and synthetic, precipitated calcium carbonates, generally in the form of a ground particulate which often comprises at least 98 weight percent CaCO₃ with the remainder being other inorganics such as magnesium carbonate, iron oxide, and alumino-silicates; surface-treated calcium carbonates; talc, including fibrous, nodular, needle shaped, and lamellar talc; glass spheres, both hollow and solid, and surface-treated glass spheres typically having coupling agents such as silane coupling agents and/or containing a conductive coating; and kaolin, including hard, soft, calcined kaolin, and kaolin comprising various coatings known to the art to facilitate the dispersion in and compatibility with the thermoset resin; mica, including metallized mica and mica surface treated with aminosilane or acryloylsilane coatings to impart good physical properties to compounded blends; feldspar and nepheline syenite; silicate spheres; flue dust; cenospheres; fillite; aluminosilicate (armospheres), including silanized and metallized aluminosilicate; natural silica sand; quartz; quartzite; perlite; Tripoli; diatomaceous earth; synthetic silica, including those with various silane coatings; and the like; and combinations thereof.

Fibrous fillers include short inorganic fibers, including processed mineral fibers such as those derived from blends comprising at least one of aluminium silicates, aluminum oxides, magnesium oxides, and calcium sulfate hemihydrate. Also included among fibrous fillers are single crystal fibers or “whiskers” including silicon carbide, alumina, boron carbide, carbon, iron, nickel, copper. Also included among fibrous fillers are glass fibers, including textile glass fibers such as E, A, C, ECR, R, S, D, and NE glasses and quartz. Preferred fibrous fillers include glass fibers having a diameter in a range of about 5 to about 25 micrometers and a length before compounding in a range of about 0.5 to about 4 centimeters. Many other suitable fillers are described in U.S. Pat. No. 6,352,782 B2 to Yeager et al.

The curable composition can also contain adhesion promoters to improve adhesion of the thermosetting resin to the filler or to an external coating or substrate. Also possible is treatment of the aforementioned inorganic fillers with adhesion promoter to improve adhesion. Adhesion promoters include chromium complexes, silanes, titanates, zirco-aluminates, propylene maleic anhydride copolymers, reactive cellulose esters and the like. Chromium complexes include those sold by DuPont under the trade name VOLAN®. Silanes include molecules having the general structure (RO)₍₄₋ₙ₎SiYₙ wherein n=1-3, R is an alkyl or aryl group and Y is a reactive functional group which can enable formation of a bond with a polymer molecule. Particularly useful examples of coupling agents are those having the structure (RO)₃SiY. Typical examples include vinyl triethoxysilane, vinyl tris(2-methoxy)silane, phenyl trimethoxysilane, γ-methacryloxypropyltrimethoxy silane, γ-aminopropyltriethoxysilane, γ-glycidoxypropyltrimethoxysilane, γ-mercaptopropyltrimethoxysilane, and the like. Silanes further include molecules lacking a reactive functional group, such as, for example, trimethoxyphenylsilane. The adhesion promoter can be included in the thermosetting resin itself, or coated onto any of the fillers described above to improve adhesion between the filler and the thermosetting resin. For example such promoters can be used to coat a silicate fiber or filler to improve adhesion of the resin matrix.

When present, the particulate filler can be used in an amount of about 5 to about 95 weight percent, based on the total weight of the curable composition. The particulate filler amount can be about 20 to about 90 weight percent, specifically about 40 to about 80 weight percent.

When present, the fibrous filler can be used in an amount of about 2 to about 80 weight percent, based on the total weight of the curable composition. The fibrous filler amount can be about 10 to about 60 weight percent, specifically about 15 to about 40 weight percent, more specifically about 15 to about 30 weight percent.

The curable composition may, optionally, further comprise one or more additives known in the art, such as, for example, dyes, pigments, colorants, antioxidants, heat stabilizers, light stabilizers, plasticizers, lubricants, flow modifiers, drip retardants, antiblocking agents, antistatic agents, flow-promoting agents, processing aids, substrate adhesion agents, mold release agents, toughening agents, low-profile additives, stress-relief additives, flame retardants, and the like, and combinations thereof. Those skilled in the art can select suitable additives and determine suitable amounts without undue experimentation.

There is no particular limitation on the method by which the curable composition is prepared. The composition can be prepared by forming an intimate blend comprising the capped poly(arylene ether) and the thermoset resin.

There is no particular limitation on the method by which the curable composition can be cured. The composition may, for example, be cured thermally or by using irradiation techniques, including radio frequency heating, UV irradiation and electron beam irradiation. For example, the composition can be cured by initiating chain-reaction curing with 10 seconds of radio frequency heating. When heat curing is used, the temperature selected can be in a range of about 80° to about 300° C. The heating period can be in a range of about 5 seconds to about 24 hours. Curing can be staged to produce a partially cured and often tack-free resin, which then is fully cured by heating for longer periods or at higher temperatures.

One embodiment is a cured composition obtained by curing any of the above-described curable compositions. It will be understood that the term “curing” includes partially curing and fully curing. Because the components of the curable composition can react with each other during curing, the cured compositions can be described as comprising the reaction products of the curable composition components. Another embodiment is an article comprising any of the cured compositions.

Molding compositions and laminate compositions are only a few of the many potential applications possible for the curable composition. Potential applications for the use of the curable composition include those known in the art for thermosetting resins, particularly those requiring properties such as high glass transition temperature, toughness, excellent dielectric properties, and good flow properties.

The invention is further illustrated by the following non-limiting examples.

### EXAMPLES 1-3, COMPARATIVE EXAMPLES 1 AND 2

The following examples illustrate the large and unexpected improvement in catalyst metal removal from capped poly(arylene ether) when the catalyst metal is removed from the reaction mixture after the poly(arylene ether) is treated with a capping agent.

The uncapped poly(arylene ether) starting material was the product of copper-catalyzed oxidative copolymerization of 2,6-dimethylphenol in toluene. The reaction mixture had the following initial composition: 50192 parts by weight of 2,6-dimethylphenol, 109581 parts by weight of toluene, 503 parts by weight of di-n-butylamine, 1175 parts by weight of dimethyl-n-butylamine, 264 parts by weight of a diamine mix containing N,N′-dibutylethylenediamine and didecyl dimethyl ammonium chloride, and 353 parts by weight of a catalyst mix containing 6.5 weight percent Cu₂O in aqueous hydrogen bromide. The concentration of copper in the polymerization reaction mixture was about 125 parts per million by weight based on the total weight of the reaction mixture, or about 420 parts per million by weight based on the weight of poly(arylene ether) product. The concentration of poly(arylene ether) in the polymerization reaction mixture was 29.8 weight percent based on the total weight of the reaction mixture. The product (uncapped) poly(arylene ether) had an intrinsic viscosity of 0.06 deciliter per gram measured in chloroform at 25° C.

4-Dimethylaminopyridine (DMAP) was obtained in prilled form from Riley Industries and used as received. Methacrylic anhydride was obtained from Degussa and used as received. The chelant was the trisodium salt of nitrilotriacetic acid (Na₃NTA), which was used as a 4 weight percent aqueous solution.

One thousand grams of the polymerization reaction mixture were placed in a two-liter vessel equipped with a mechanical stirrer, a thermocouple probe, a nitrogen gas inlet, an addition funnel, and a Dean Stark reflux condenser. Water produced by the oxidative polymerization process was removed using azeotropic distillation of toluene. The temperature was decreased to 90° C. and 9 grams of DMAP were added, followed by the drop-wise addition of 143 grams of methacrylic anhydride over 10 minutes. The resulting mixture was stirred for 6 hours at 90° C., then allowed to cool to 23° C.

Copper was removed from the above capping reaction mixture by washing with the 4 weight percent aqueous Na₃NTA solution. The capping reaction mixture contained approximately 30% by weight solids when treated with Na₃NTA. The capping reaction mixture and the Na₃NTA solution were shaken, and the phases were allowed to separate. For example, 500 grams of capping reaction mixture were combined with 83 grams of the 4 weight percent aqueous Na₃NTA solution in a separatory funnel. The two phases were vigorously mixed, then allowed to separate. The time required for phase separation did not appear to be dependent on whether the poly(arylene ether) had been capped, or on the concentration of poly(arylene ether) in the organic phase.

After washing with the chelant solution, the resulting toluene mixture was split into two batches, and one of the two batches was concentrated to 45 weight percent capped poly(arylene ether), based on the total weight of the batch. The capped poly(arylene ether) was precipitated by the addition of four equivalents of methanol by volume (that is, using a solution-to-methanol volume ratio of 1 to 4), isolated by filtration, washed with methanol, and dried. The amount of copper in the capped poly(arylene ether) was determined using inductively coupled plasma-optical emission spectrometry (ICP-OES).

Intrinsic viscosities of isolated poly(arylene ether)s were measured at 25° C. in chloroform on samples that had been dried for 1 hour at 125° C. under vacuum. The results, expressed in deciliters per gram (dL/g) are presented in Table 1 as “Final resin IV (dL/g)”.

Table 1 lists the amount of residual copper in each precipitated poly(arylene ether) as a function of poly(arylene ether) capping (“Capped” or “Uncapped”) and the concentration of poly(arylene ether) in the solution from which it was precipitated (30 weight percent (“wt %”) or 45 wt %). Example 1 represents capped poly(arylene ether) precipitated from 30 weight percent capped poly(arylene ether) solution. Examples 2 and 3 represent capped poly(arylene ether)s precipitated from 45 weight percent capped poly(arylene ether) solutions. In the case of Example 3, however, the reaction mixture was concentrated to 45 weight percent poly(arylene ether) prior to the addition of methacrylic anhydride, it was then diluted to 30 weight percent capped poly(arylene ether) prior to the copper chelation step, and then concentrated to 45 weight percent capped poly(arylene ether) prior to precipitation of the capped poly(arylene ether). Comparative Examples 1 and 2 represent poly(arylene ether)s that were not treated with methacrylic anhydride, but were precipitated from 30 weight percent and 45 weight percent solutions, respectively.

TABLE 1

| | Ex. 1 | Ex. 2 | Ex. 3 | C. Ex. 1 | C. Ex. 2 |
|---|---|---|---|---|---|
| Methacrylate capping | Capped | Capped | Capped | Uncapped | Uncapped |
| Amount of poly(arylene | 30 | 30 | 45 | — | — |
| ether) in solution during | | | | | |
| capping(wt %) | | | | | |
| Amount of poly(arylene | 30 | 30 | 30 | 30 | 30 |
| ether) in solution during | | | | | |
| Cu removal (wt %) | | | | | |
| Amount of poly(arylene | 30 | 45 | 45 | 30 | 45 |
| ether) in solution used for | | | | | |
| precipitation (wt %) | | | | | |
| Residual copper content | 0.5 | 0.2 | 0.4 | 2.5 | 2.4 |
| after catalyst removal | | | | | |
| (ppm) | | | | | |
| Final resin IV (dL/g) | 0.066 | 0.059 | 0.072 | 0.065 | 0.060 |

It can be seen from Table 1 that the amount of residual copper is greatly and surprisingly reduced when the poly(arylene ether) is capped prior to removal of the metal catalyst (Example 1 versus Comparative Example 1, and Example 2 versus Comparative Example 2). Specifically, the amount of residual copper is reduced by 80% in Example 1 when compared to Comparative Example 1, and by 92% in Example 2 when compared to Comparative Example 2. In addition, the absolute concentrations of catalyst metal in Examples 1-3 are extremely low.

This written description uses examples to disclose the invention, including the best mode, and also to enable any person skilled in the art to male and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application tales precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A method of preparing a capped poly(arylene ether) resin, comprising:
oxidatively polymerizing a phenolic monomer in the presence of a solvent and a catalyst metal to form a polymerization reaction mixture comprising a poly(arylene ether), solvent, catalyst metal, and water;
separating water from the polymerization reaction mixture to form a solution comprising poly(arylene ether), solvent, and catalyst metal;
combining a capping agent with the solution comprising poly(arylene ether), solvent, and catalyst metal, and reacting the poly(arylene ether) and the capping agent to form a capping reaction mixture comprising a capped poly(arylene ether), solvent, and catalyst metal;
combining a chelant with the capping reaction mixture; and
separating the combined chelant and capping reaction mixture to yield a purified solution and an aqueous phase; wherein the purified solution comprises capped poly(arylene ether) and solvent; and wherein the aqueous phase comprises chelant and catalyst metal.

2. The method of claim 1, further comprising removing solvent from the polymerization reaction mixture or the solution comprising poly(arylene ether), solvent, and catalyst metal; wherein said removing solvent is conducted prior to said combining a capping agent with the solution comprising poly(arylene ether), solvent, and catalyst metal.

3. The method of claim 1, further removing solvent from the purified solution.

4. The method of claim 1, further comprising isolating the capped poly(arylene ether).

5. The method of claim 4, wherein said isolating the capped poly(arylene ether) comprises using a method selected from the group consisting of precipitation, devolatilizing extrusion, spray drying, wiped film evaporation, flake evaporation, and combinations of the foregoing methods.

6. The method of claim 4, wherein the isolated capped poly(arylene ether) comprises less than or equal to 2 parts per million by weight of catalyst metal.

7. The method of claim 4, wherein the isolated capped poly(arylene ether) comprises about 0.1 to 2 parts per million by weight of catalyst metal.

8. The method of claim 4, wherein the isolated capped poly(arylene ether) comprises about 0.1 to about 1 part per million by weight of catalyst metal.

9. The method of claim 1, wherein the phenolic monomer comprises a monohydric phenol selected from the group consisting of 2,6-dimethylphenol, 2,6-diphenylphenol, 2-methylphenol, 2,5-dimethylphenol, 2,3,6-trimethylphenol, and combinations thereof; and a dihydric phenol selected from the group consisting of 3,3′,5,5′-tetramethyl-4,4′-biphenol, 2,2-bis(3-methyl-4-hydroxyphenyl)propane, 2,2-bis(3,5-dimethyl-4-hydroxyphenyl)propane, 1,1-bis(4-hydroxyphenyl)methane, 1,1-bis(4-hydroxyphenyl)ethane, 2,2-bis(4-hydroxyphenyl)propane 2,2-bis(4-hydroxyphenyl)butane, 2,2-bis(4-hydroxyphenyl)octane, 1,1-bis(4-hydroxyphenyl)propane, 1,1-bis(4-hydroxyphenyl)-n-butane, bis(4-hydroxyphenyl)phenylmethane, 2,2-bis(4-hydroxy-3-methylphenyl)propane, 1,1-bis(4-hydroxy-3-methylphenyl)cyclohexane, 1,1-bis(4-hydroxy-3,5-dimethylphenyl)cyclopentane, 1,1-bis(4-hydroxy-3,5-dimethylphenyl)cyclohexane, 1,1-bis(4-hydroxy-3-methylphenyl)cycloheptane, 1,1-bis(4-hydroxy-3,5-dimethylphenyl)cycloheptane, 1,1-bis(4-hydroxy-3-methylphenyl)cyclooctane, 1,1-bis(4-hydroxy-3,5-dimethylphenyl)cyclooctane, 1,1-bis(4-hydroxy-3-methylphenyl)cyclononane, 1 1,1-bis(4-hydroxy-3,5-dimethylphenyl)cyclononane, 1,1-bis(4-hydroxy-3-methylphenyl)cyclodecane, 1,1-bis(4-hydroxy-3,5-dimethylphenyl)cyclodecane, 1,1-bis(4-hydroxy-3-methylphenyl)cycloundecane, 1,1-bis(4-hydroxy-3,5-dimethylphenyl)cycloundecane, 1,1-bis(4-hydroxy-3-methylphenyl)cyclododecane, 1,1-bis(4-hydroxy-3,5-dimethylphenyl)cyclododecane, 1,1-bis(4-hydroxy-3-t-butylphenyl)propane, 2,2-bis(4-hydroxy-2,6-dimethylphenyl)propane 2,2-bis(4-hydroxy-3-bromophenyl)propane, 1,1-bis(4-hydroxyphenyl)cyclopentane, 1,1-bis(4-hydroxyphenyl)cyclohexane, and combinations thereof.

10. The method of claim 1, wherein the solvent is selected from the group consisting of halogenated aliphatic hydrocarbon solvents, aromatic hydrocarbon solvents, halogenated aromatic hydrocarbon solvents, and combinations thereof.

11. The method of claim 1, wherein the solvent is toluene.

12. The method of claim 1, wherein the catalyst metal is selected from the group consisting of copper, manganese, cobalt, and mixtures thereof.

13. The method of claim 1, wherein the catalyst metal is copper.

14. The method of claim 1, wherein said separating water from the polymerization reaction mixture comprises using a technique selected from the group consisting of liquid-liquid centrifugation, azeotropic distillation, adsorption, diffusion through a membrane, and combinations thereof.

15. The method of claim 1, wherein the capping agent is methacrylic anhydride.

16. The method of claim 1, wherein the chelant is selected from the group consisting of polyalkylenepolyamine polycarboxylic acids, aminopolycarboxylic acids, aminocarboxylic acids, polycarboxylic acids, alkali metal salts of the foregoing acids, alkaline earth metal salts of the foregoing acids, mixed alkali metal-alkaline earth metal salts of the foregoing acids, and combinations thereof.

17. The method of claim 1, wherein the chelant is an alkali metal salt of nitrilotriacetic acid.

18. The method of claim 17, wherein the alkali metal salt of nitrilotriacetic acid is used in an amount of about 1 to about 15 moles per mole of catalyst metal.

19. The method of claim 1, wherein said separating the combined chelant and capping reaction mixture comprises using a technique selected from the group consisting of liquid-liquid centrifuge, decantation, and combinations thereof.

20. A method of preparing a capped poly(arylene ether) resin comprising:
oxidatively polymerizing 2,6-dimethylphenol in the presence of toluene and a polymerization catalyst comprising copper to form a polymerization reaction mixture comprising a poly(arylene ether), toluene, copper, and water;
separating water from the polymerization reaction mixture to form a solution comprising poly(arylene ether), toluene, and copper;
combining (meth)acrylic anhydride with the solution comprising poly(arylene ether), toluene, and copper, and reacting the (meth)acrylic anhydride and the poly(arylene ether) to form a capping reaction mixture comprising a (meth)acrylate-capped poly(arylene ether), toluene, and copper;
combining an aqueous chelant solution with the capping reaction mixture; wherein the aqueous chelant solution comprises an alkali metal salt of nitrilotriacetic acid;
separating the combined aqueous chelant solution and capping reaction mixture to yield a purified solution and an aqueous phase; wherein the purified solution comprises (meth)acrylate-capped poly(arylene ether) and toluene; and wherein the aqueous phase comprises chelant and copper; and
isolating the (meth)acrylate-capped poly(arylene ether);
wherein the isolated (meth)acrylate-capped poly(arylene ether) comprises about 0.1 to about 1 part per million by weight of copper.

21. A method of preparing a capped poly(arylene ether) resin comprising:
oxidatively polymerizing 2,6-dimethylphenol in the presence of toluene and a polymerization catalyst comprising copper to form a polymerization reaction mixture comprising a poly(arylene ether), toluene, copper, and water;
separating water from the polymerization reaction mixture to form a solution comprising poly(arylene ether), toluene, and copper;
removing toluene from the polymerization reaction mixture or the solution comprising poly(arylene ether), toluene, and copper;
combining (meth)acrylic anhydride with the solution comprising poly(arylene ether), toluene, and copper, and reacting the (meth)acrylic anhydride and the poly(arylene ether) to form a capping reaction mixture comprising a (meth)acrylate-capped poly(arylene ether), toluene, and copper;
adding toluene to the capping reaction mixture to form a diluted capping reaction mixture;
combining an aqueous chelant solution with the diluted capping reaction mixture; wherein the aqueous chelant solution comprises an alkali metal salt of nitriloacetic acid;
separating the combined aqueous chelant solution and diluted capping reaction mixture to yield a purified solution and an aqueous phase; wherein the purified solution comprises (meth)acrylate-capped poly(arylene ether) and toluene; and wherein the aqueous phase comprises chelant and copper;
removing toluene from the purified solution to yield a concentrated purified solution; and
isolating the (meth)acrylate-capped poly(arylene ether) from the concentrated purified solution;
wherein the isolated (meth)acrylate-capped poly(arylene ether) comprises about 0.1 to about 1 part per million by weight of copper.

22. A method of preparing a capped poly(arylene ether) resin comprising:
oxidatively polymerizing 2,6-dimethylphenol in the presence of toluene and a polymerization catalyst comprising copper to form a polymerization reaction mixture comprising a poly(arylene ether), toluene, copper, and water;
separating water from the polymerization reaction mixture to form a solution comprising poly(arylene ether), toluene, and copper;
combining (meth)acrylic anhydride with the solution comprising poly(arylene ether), toluene, and copper, and reacting the (meth)acrylic anhydride and the poly(arylene ether) to form a capping reaction mixture comprising a (meth)acrylate-capped poly(arylene ether), toluene, and copper;
combining an aqueous chelant solution with the capping reaction mixture; wherein the aqueous chelant solution comprises an alkali metal salt of nitrilotriacetic acid;
separating the combined aqueous chelant solution and capping reaction mixture to yield a purified solution and an aqueous phase; wherein the purified solution comprises (meth)acrylate-capped poly(arylene ether) and toluene; and wherein the aqueous phase comprises chelant and copper;
precipitating the (meth)acrylate-capped poly(arylene ether) from the purified solution;
dissolving the precipitated (meth)acrylate-capped poly(arylene ether) in toluene to form a (meth)acrylate-capped poly(arylene ether) solution;
removing toluene from the (meth)acrylate-capped poly(arylene ether) solution to yield a concentrated (meth)acrylate-capped poly(arylene ether) solution; and
isolating the (meth)acrylate-capped poly(arylene ether) from the concentrated (meth)acrylate-capped poly(arylene ether) solution;
wherein the isolated (meth)acrylate-capped poly(arylene ether) comprises about 0.1 to about 1 part per million by weight of copper.

23. A method of removing metal ions from a capped poly(arylene ether) resin, comprising:
combining
a chelant,
water, and
a solution comprising a capped poly(arylene ether), a metal ion, and solvent; and
separating the combined chelant, water, and solution to form a purified solution and an aqueous phase; wherein the purified solution comprises capped poly(arylene ether) and solvent; and wherein the aqueous phase comprises chelant and metal ion.

24. The method of claim 23, further comprising isolating the capped poly(arylene ether), wherein the isolated capped poly(arylene ether) comprises less than or equal to 2 parts per million by weight of metal ion.

25. The method of claim 23, further comprising isolating the capped poly(arylene ether), wherein the isolated capped poly(arylene ether) comprises about 0.1 to 2 parts per million by weight of catalyst metal ion.

26. A capped poly(arylene ether) prepared by the method of claim 6.

27. A capped poly(arylene ether) prepared by a method comprising oxidative polymerization of a monohydric phenol in the presence of a catalyst comprising a catalyst metal, wherein the capped poly(arylene ether) comprises less than or equal to 2 parts per million by weight of the catalyst metal.

28. The capped poly(arylene ether) of claim 27, comprising about 0.2 to about 1 part per million by weight of the catalyst metal.

29. A capped poly(arylene ether) having the structure 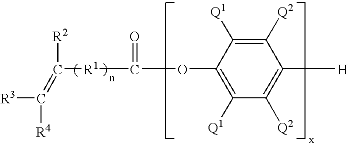
wherein each occurrence of Q¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; x is 1 to about 40; R¹ is C₁-C₁₂ hydrocarbylene; n is 0 or 1; and R² and R³ and R⁴ are each independently hydrogen or C₁-C₁₈ hydrocarbyl;
wherein the capped poly(arylene ether) has an intrinsic viscosity of about 0.03 to about 0.20 deciliter per gram, measured at 25° C. in chloroform;
wherein the capped poly(arylene ether) is synthesized by a method comprising oxidative polymerization of a monohydric phenol in the presence of a catalyst comprising a catalyst metal; and
wherein the capped poly(arylene ether) comprises less than or equal to 2 parts per million by weight of catalyst metal.

30. The capped poly(arylene ether) of claim 29, comprising about 0.2 to about 1 part per million by weight of the catalyst metal.

31. A capped poly(arylene ether) having the structure 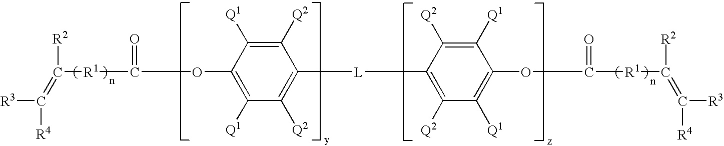
wherein each occurrence of Q¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of y and z is independently 0 to about 100 with the proviso that the sum of y and z is 2 to about 100; each occurrence of R₁ is independently C₁-C₁₂ hydrocarbylene; each occurrence of n is independently 0 or 1; each occurrence of R²-R⁴ is independently hydrogen or C₁-C₁₈ hydrocarbyl; and L has the structure 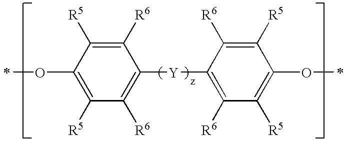
wherein each occurrence of R⁵ and R⁶ is independently selected from the group consisting of hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; z is 0 or 1; and Y has a structure selected from the group consisting of 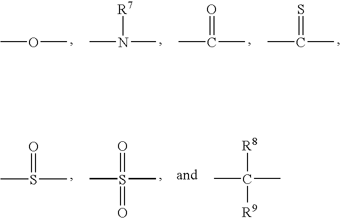
wherein each occurrence of R⁷ is independently selected from the group consisting of hydrogen and C₁-C₁₂ hydrocarbyl, and each occurrence of R⁸ and R⁹ is independently selected from the group consisting of hydrogen, C₁-C₁₂ hydrocarbyl, and C₁-C₆ hydrocarbylene wherein R⁸ and R⁹ collectively form a C₄-C₁₂ alkylene group;
wherein the capped poly(arylene ether) has an intrinsic viscosity of about 0.03 to about 0.20 deciliter per gram, measured at 25° C. in chloroform;
wherein the capped poly(arylene ether) is synthesized by a method comprising oxidative polymerization of a monohydric phenol and a dihydric phenol in the presence of a catalyst comprising a catalyst metal; and
wherein the capped poly(arylene ether) comprises less than or equal to 2 parts per million by weight of catalyst metal.

32. The capped poly(arylene ether) of claim 31, comprising about 0.2 to about 1 part per million by weight of the catalyst metal.

33. A capped poly(arylene ether) having the structure 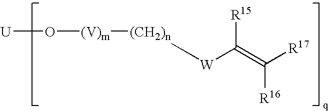
wherein U is a C₆-C₁₈ aryl group optionally substituted with one or more C₁-C₆ alkyl groups; V is a phenylene ether group; m is 1 to about 100; n is 0 to 6; W is a phenylene group or an oxygen atom; each occurrence of R¹⁵, R¹⁶, and R¹⁷ is independently selected from the group consisting of hydrogen, C₁-C₆ alkyl, C₂-C₆ alkenyl, and C₂-C₆ alkynyl; and q is 1 to 4;
wherein the capped poly(arylene ether) is prepared by a process comprising oxidatively polymerizing a phenolic monomer in the presence of a catalyst metal; and
wherein the capped poly(arylene ether) comprises less than or equal to 2 parts per million by weight of catalyst metal.

34. The capped poly(arylene ether) of claim 33, comprising about 0.2 to about 1 part per million by weight of the catalyst metal.

35. A curable composition comprising the capped poly(arylene ether) of claim 26.
